(19) United States
(12) Patent Application Publication
(10) Pub. No.: US 2006/0086388 A1
(43) Pub. Date: Apr. 27, 2006

(54) Venting device for degassing a flow of liquid in a closed system

(76) Inventor: Blake Fye, Peru, IN (US)

Correspondence Address: BAKER & DANIELS LLP, 300 NORTH MERIDIAN STREET, SUITE 2700, INDIANAPOLIS, IN, 46204, US

(21) Appl. No.: 10/974,393

(22) Filed: Oct. 27, 2004

(51) Int. Cl. F16K 24/00

(52) U.S. Cl. 137/202

(57) ABSTRACT

An apparatus for removing gas from a flow of liquid includes a shell having an inner cavity for carrying the flow of liquid. A venting device includes an inlet in fluid communication with the cavity of the shell, an outlet in fluid communication with ambient air, and a chamber interconnecting the inlet and the outlet. A float valve device controls fluid flow between the chamber and the outlet. The float valve device includes a float that follows a level of the liquid in the chamber. A pivot arm is connected to the float and is actuated by the float such that the pivot arm prevents fluid flow from the chamber to the outlet when the level of the liquid in the chamber is above a predetermined level, and allows fluid flow from the chamber to the outlet when the level of the liquid in the chamber is below the predetermined level.

### BACKGROUND OF THE INVENTION

1. Field of the Invention

The present invention relates to an apparatus for removing air or other gas from a flow of liquid, and, more particularly, to an apparatus including a venting device for removing air or other gas from a flow of water.

2. Description of the Related Art

It is known to use a venting device to remove air from a flow of water. Such flows of water are commonly used in conjunction with pressure booster systems, heat exchangers, pumps, and water heaters, for example. The venting device may include a housing through which the water flows. Small air bubbles within the water flow may float to the upper surface of the water, and then the air within the bubbles may be released into the upper portion of the housing. A port or opening may be provided at the top of the housing for releasing air from the housing. In order to prevent water within the housing from also escaping through the opening, a float may be provided within the housing to seal the opening when the upper surface of the water in the housing reaches a certain vertical level. As air is released from the flow of water, the level of the water drops, and the float should drop along with the water level, thereby unsealing the opening.

A problem is that after the float is biased against the top wall of the housing to thereby seal the opening, the float may adhere to the top wall of the housing after the water level in the housing has dropped. This is particularly liable to happen when the float and/or the top wall of the housing are wet. With the float continuing to seal the opening, air is prevented from leaving the housing through the opening.

What is needed in the art is an apparatus for removing air from a flow of liquid wherein an air-release port may be sealed when the water reaches a predetermined vertical level, and the air-release port is reliably unsealed when the water drops below the predetermined vertical level.

### SUMMARY OF THE INVENTION

The present invention provides a venting device for degassing a flow of liquid including a float whose vertical motion rotates a pivot arm that opens and closes a fluid port. The pivot arm may have a first end connected with the float, a pivot point about which the arm rotates, and an opposite second end that extends well beyond the pivot point to thereby counterbalance the first end and enable the first end to be of greater length.

The invention comprises, in one form thereof, an apparatus for removing gas from a flow of liquid, including a shell having an inner cavity for carrying the flow of liquid. A venting device includes an inlet in fluid communication with the cavity of the shell, an outlet in fluid communication with ambient air, and a chamber interconnecting the inlet and the outlet. A float valve device controls fluid flow between the chamber and the outlet. The float valve device includes a float that follows a level of the liquid in the chamber. A pivot arm is connected to the float and is actuated by the float such that the pivot arm prevents fluid flow from the chamber to the outlet when the level of the liquid in the chamber is above a predetermined level, and allows fluid flow from the chamber to the outlet when the level of the liquid in the chamber is below the predetermined level.

The invention comprises, in another form thereof, a venting device for releasing gas from a closed vessel containing a liquid. The venting device includes an inlet configured to be in fluid communication with the vessel, an outlet in fluid communication with ambient air, a chamber interconnecting the inlet and the outlet, and a valve device for controlling fluid flow between the chamber and the outlet. The valve device includes a pivoting arrangement actuated by changes in a level of the liquid in the chamber such that the valve device prevents fluid from flowing from the chamber to the outlet when the level of the liquid in the chamber is above a predetermined level. The valve device allows fluid to flow from the chamber to the outlet when the level of the liquid in the chamber is below the predetermined level.

The invention comprises, in yet another form thereof, a venting device for releasing gas from a closed vessel containing a liquid. The venting device includes a chamber receiving a fluid flow from the vessel. A valve device controls fluid flow out of the chamber through a port. The valve device includes a pivot arm that is pivoted as a result of changes in a level of the liquid in the chamber such that the pivot arm selectively substantially seals and unseals the port.

An advantage of the present invention is that the relatively long length of the pivot arm results in a greater level of torque being applied to a projection that seals a port, which may overcome any adhesion between the projection and the port, thereby promoting smooth operation and making it less likely that the valve will become stuck in a closed position. Further, the increased leverage provided by a longer pivot arm may also prevent the valve from sticking in an open position.

Another advantage is that the pivot arm may include a counterbalancing extension, which enables the length of the pivot arm to be greater without the pivot arm being unduly lop-sided.

Yet another advantage is that, due to the length of the pivot arm, the projection may seal the port very gradually, thereby slowing the change of pressure in the chamber and extending the useful lives of the components.

Still another advantage is that the ball bearing performs a check valve function, i.e., allows air flow in only one direction, to thereby prevent ambient air from flowing through the venting device into the housing in a reverse direction, even when there is a vacuum pressure within the housing.

### BRIEF DESCRIPTION OF THE DRAWINGS

The above mentioned and other features and objects of this invention, and the manner of attaining them, will become more apparent and the invention itself will be better understood by reference to the following description of embodiments of the invention taken in conjunction with the accompanying drawings, wherein:

FIG. 1 is a schematic cross-sectional front view of one embodiment of an apparatus for removing air from a flow of liquid including one embodiment of a venting device of the present invention;

FIG. 2 is a cross-sectional view of the venting device of FIG. 1 in an open position;

FIG. 3 is a cross-sectional view of the venting device of FIG. 1 in a closed position; and

FIG. 4 is a schematic front view of the venting device of FIG. 1 used in another application.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DESCRIPTION OF THE PRESENT INVENTION

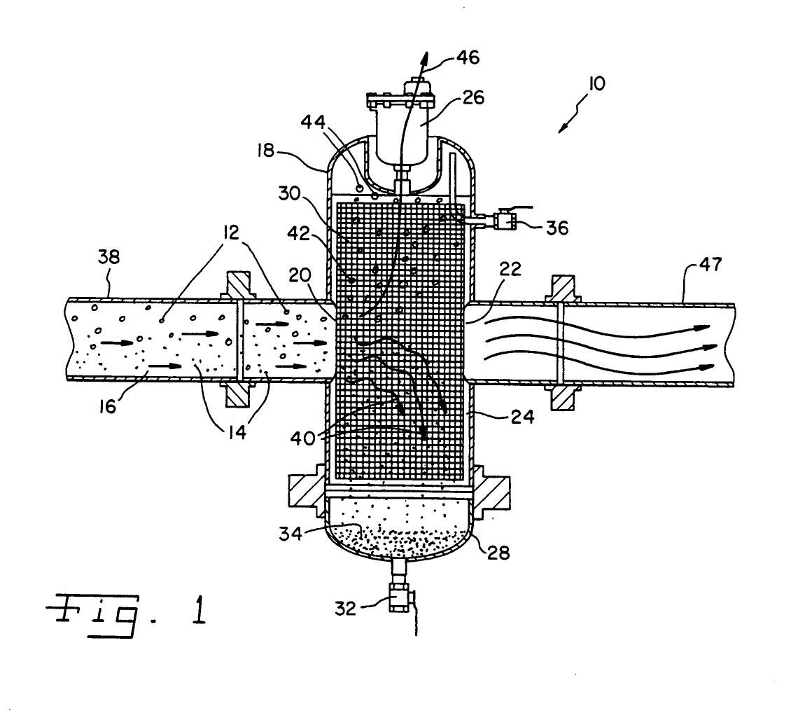

Referring now to the drawings, and particularly to FIG. 1, there is shown one embodiment of a one-way venting device 26 of the present invention in use within an apparatus 10 for removing entrained air and air microbubbles 12 and/or particles of dirt or debris 14 from a flow of liquid, such as a flow of water 16. Apparatus 10 includes a shell 18 having an inlet 20, an outlet 22, an elongate inner cavity 24 in fluid communication with each of inlet 20 and outlet 22, and a removable bottom section 28. Venting device 26 is operable for releasing gas bubbles, such as air bubbles, from cavity 24, and may be connected to an upper end of shell 18 as shown. Bottom section 28 can be separated from the remainder of shell 18 in order to insert a coalescing medium assembly 30 into cavity 24, or to remove assembly 30 therefrom, such as for cleaning. Bottom section 28 includes a valve 32 through which settled dirt particles 34 can be selectively drained or otherwise removed from bottom section 28. Shell 18 also includes a valve 36 through which the pressure at the top of cavity 24 can be selectively equalized with ambient air pressure.

In operation, a flow of water 16 including entrained air and air microbubbles 12 and dirt particles 14 passes through inlet 20 via a conduit 38. The speed of the flow is reduced in cavity 24 by virtue of the larger cross-sectional area of cavity 24 in comparison with that of conduit 38. Dirt particles 14 may impinge upon coalescing medium assembly 30, which can cause particles 14 to fall into bottom section 28, as indicated by arrows 40. Thus, coalescing medium assembly 30 strains or filters dirt particles 14 from the flow of water 16. Entrained air is pulled out of solution in cavity 24 and forms microbubbles 42 that cling to coalescing medium assembly 30. Microbubbles 42 and other microbubbles 12 from water flow 16 collect and coalesce on coalescing medium assembly 30 to form larger air bubbles 44. Larger bubbles 44 can quickly rise to the top of cavity 24 and pass through venting device 26 to ambient air, as indicated by arrow 46. The flow of water 16, having had air and/or debris at least partially removed therefrom, exits cavity 24 via outlet 22 and conduit 47.

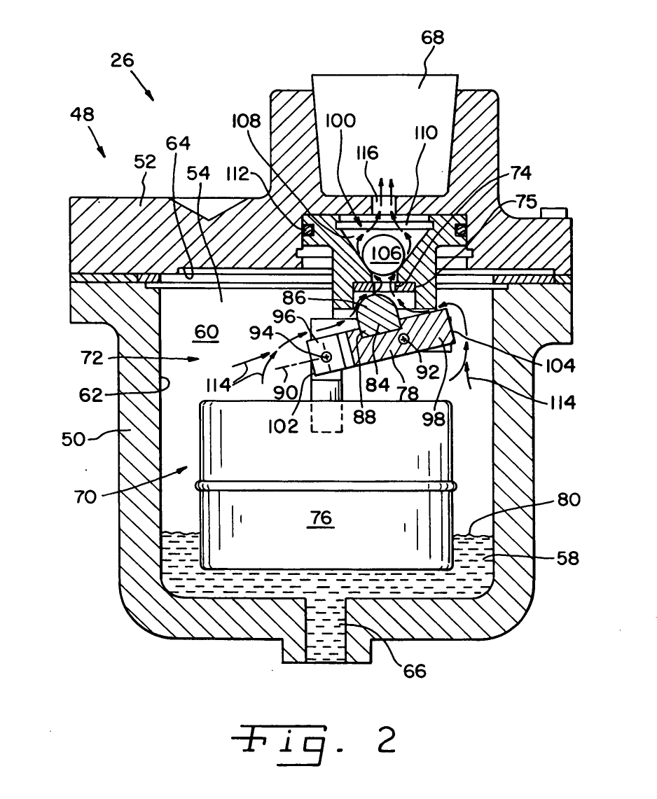

One embodiment of venting device 26 of FIG. 1 is shown in FIG. 2 in an open position. Venting device 26 includes a vessel 48 having a body 50 and a lid 52 for capping an open end 54 of body 50. Body 50 may retain a liquid such as water 58 therein. A chamber 60 is defined between an inner wall 62 of body 50 and a lower surface 64 of lid 52.

Vessel 48 includes an inlet 66 in fluid communication with cavity 24 of shell 18 and with chamber 60. Thus, chamber 60 may receive a fluid flow, including a mixture of water 58 and entrained air, from vessel 48. Vessel 48 also includes an outlet 68 in fluid communication with ambient air. Chamber 60 fluidly interconnects inlet 66 and outlet 68.

Disposed within chamber 60 is a float valve device 70 for controlling fluid flow between chamber 60 and outlet 68. Float valve device 70 includes a pivoting arrangement 72 for selectively opening and closing, i.e., sealing and unsealing, a port 74. Pivoting arrangement 72 may include a float 76 connected to a pivot arm 78 and having a density less than that of water 58.

Port 74 fluidly interconnects chamber 60 and outlet 68 when port 74 is unsealed. Port 74 may be in the form of a circular throughhole in a gasket 75.

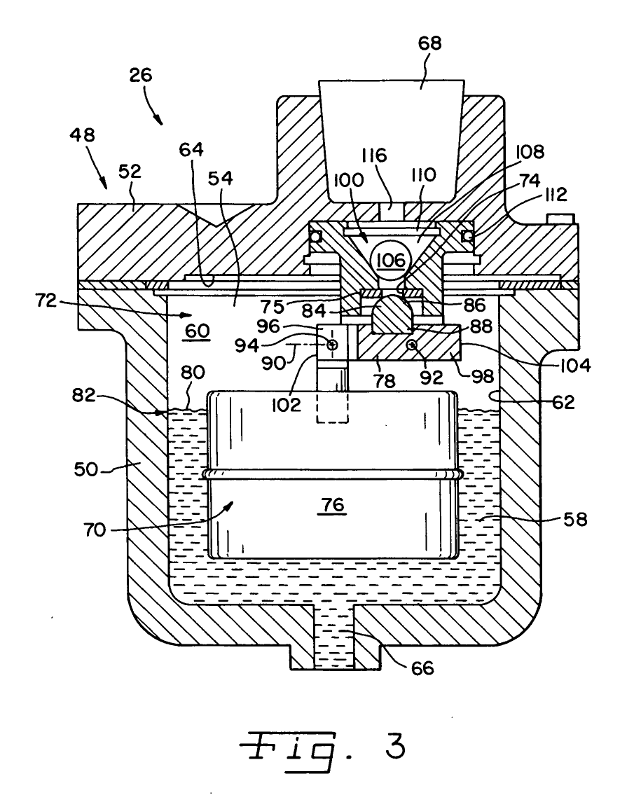

Pivoting arrangement 72 may be actuated by changes in a level of water 58 in chamber 60 such that valve device 70, and pivot arm 78 in particular, may prevent fluid from flowing from chamber 60 to outlet 68 when the level of water 58 in chamber 60 is above a predetermined level. In one embodiment, pivot arm 78 of pivoting arrangement 72 substantially seals port 74, as shown in FIG. 3, when an upper surface 80 of water 58 reaches a predetermined level 82 in chamber 60. Conversely, valve device 70, and pivot arm 78 in particular, may allow fluid to flow from chamber 60 to outlet 68 when the level of water 58 in chamber 60 is below a predetermined level. More specifically, pivot arm 78 of pivoting arrangement 72 may be positioned such that port 74 is unsealed, as shown in FIG. 2, when upper surface 80 of water 58 is disposed below predetermined level 82.

Float valve device 70 may be designed with a predetermined level 82 in mind at which pivoting arrangement 72 should open and close. A desired vertical level for predetermined level 82 may be selected such that, even when the mixture of water and air in chamber 60 is turbulent, only air flows outwardly through port 74 and substantially all water remains within chamber 60. A desired vertical level for predetermined level 82 may be empirically determined.

Pivot arm 78 includes a projection in the form of a head 84 having a frusto-spherical portion 86 and a cylindrical portion 88. Head 84 may extend in a direction substantially perpendicular to a longitudinal axis 90 of pivot arm 78. Pivot arm 78 may be pivotable about a port pivot axis 92 such that head 84 may seal and unseal port 74 as pivot arm 78 pivots. Port pivot axis 92 extends into the page of FIGS. 2 and 3, and may be fixed relative to body 50.

Pivot arm 78 may be connected to float 76 at a connection point which may be pivotable, such as a float pivot axis 94. Float pivot axis 94, like port pivot axis 92, extends into the page of FIGS. 2 and 3. The pivotable nature of axis 94 may allow float 76 to move vertically within chamber 60 while pivot arm 78 pivots relative to float 76. Float 76 may exert a downward force on pivot arm 78 due to gravity, i.e., the weight of float 76, or may exert an upward force on pivot arm 78 due to float 76 being pushed upward by a rising level of water 58. The length of pivot arm 78 between pivot axes 92, 94 provides leverage, i.e., torque, that advantageously increases the amount of force with which head 84 is pushed onto or pulled away from port 74.

There is a trade-off in the location of head 84 along the length of pivot arm 78. The farther head 84 is away from connection point 94, the greater the torque that is exerted on head 84. However, the closer head 84 is to connection point 94, the greater the movement of head 84 that can be achieved with a given movement of connection point 94. Head 84 may need to move downwardly a sufficient distance away from port 74 that an adequate volume of air can pass through port 74 in a given amount of time. In the embodiment shown, head 84 is closer to port pivot axis 92 than to connection point 94.

Pivot arm 78 may include a first end portion 96 disposed generally on one side of port pivot axis 92 and a second end portion 98 disposed generally on another side of port pivot axis 92. In FIG. 2, first end portion 96 is disposed generally to the left of port pivot axis 92 and second end portion 98 is disposed generally to the right of port pivot axis 92. Second end portion 98 may function to counterbalance first end portion 96. By providing a counterbalancing weight on the opposite side of port pivot axis 92, second end portion 98 enables first end portion 96 to be longer while still enabling first end portion 96 to be pushed upward with only a relatively small volume of float 76 being submerged in water 58. The additional length of first end portion 96 as enabled by second end portion 98 enables more torque to be exerted on head 84. Head 84 may tend to adhere or stick to port 74, i.e., gasket 75, particularly if there is any moisture on head 84 or gasket 75. Additionally, a check valve 100, described in more detail below, may create a vacuum on the opposite side of port 74 that inhibits head 84 from being pulled away from port 74. Thus, the additional torque provided by a longer first end portion 96 may be needed in order to unseal port 74, i.e., move pivoting arrangement 72 from the closed position of FIG. 3 to the open position of FIG. 2.

Pivot arm 78 may be formed of a homogeneous material such that the weight of pivot arm 78 on either side of port pivot axis 92 is proportional to the length of pivot arm 78 on either side of port pivot axis 92. For example, pivot arm 78 may be formed of stainless steel, brass or aluminum. In one embodiment, first end portion 96 has a length of 0.574 inch between port pivot axis 92 and a first distal tip 102 of pivot arm 78, and second end portion 98 has a length of 0.360 inch between port pivot axis 92 and a second distal tip 104 of pivot arm 78. Alternatively, a weight having a density greater than that of the remainder of pivot arm 78 may be adhered or otherwise attached to the second distal tip of pivot arm 78, thus allowing the length of second end portion 98 to be reduced while still providing enough weight to counterbalance first end portion 96.

Check valve 100 prevents ambient air from entering chamber 60 through outlet 68, even if there is a vacuum pressure within chamber 60. Yet, check valve 100 still enables air to escape chamber 60 through outlet 68. Check valve 100 may include a sphere 106 retained in a funnel-shaped space 108 by a clip 110. Clip 110 may be needed to retain sphere 106 in space 108 before check valve 100 is inserted into lid 52. An O-ring 112 may prevent air from bypassing port 74 by seeping between lid 52 and check valve 100. Thus, when pivoting arrangement 72 is in the open position as shown in FIG. 2, air may flow as indicated by arrows 114 through port 74, through check valve 100, and through a channel 116 to thereby reach outlet 68 and then exit into ambient air.

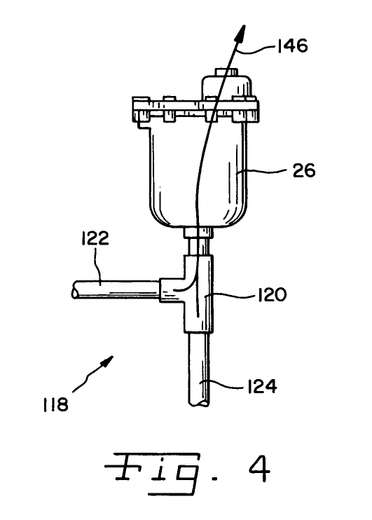

The venting device of the present invention has been described herein as being used in conjunction with apparatus 10. However, venting device 26 may also be installed on any other type of air separator or air purger. Further, venting device 26 may be installed in any pipe line. FIG. 4 illustrates an embodiment wherein venting device 26 is installed at a high point in a pipe line 118. More particularly, venting device 26 is installed at a junction 120 of a horizontal pipe 122 and a vertical pipe 124. Bubbles flowing through junction 120 may pass through venting device 26 to ambient air, as indicated by arrow 146.

The venting device of the present invention has been described herein as allowing air to escape from a turbulent mixture of water and air. However, it is to be understood that the present invention can be used to allow any gas to escape from a turbulent mixture of the gas and any liquid.

The present invention has been described herein as including a float for rotating the pivot arm. Alternatively, it is possible within the scope of the present invention for the pivot arm itself to have a density less than that of the liquid, so that the rising level of the liquid lifts the pivot arm directly. For example, the first end portion of the pivot arm may be provided with an enclosed cavity to reduce the overall density of the pivot arm.

While this invention has been described as having an exemplary design, the present invention may be further modified within the spirit and scope of this disclosure. This application is therefore intended to cover any variations, uses, or adaptations of the invention using its general principles.

What is claimed is:

1. An apparatus for removing gas from a flow of liquid, said apparatus comprising:
a shell having an inner cavity configured to carry the flow of liquid; and
a venting device including:
an inlet in fluid communication with said cavity of said shell;
an outlet in fluid communication with ambient air;
a chamber interconnecting said inlet and said outlet; and
a float valve device configured to control fluid flow between said chamber and said outlet, said float valve device including:
a float configured to follow a level of the liquid in said chamber; and
a pivot arm connected to said float and configured to be actuated by said float such that said pivot arm prevents fluid flow from said chamber to said outlet when the level of the liquid in said chamber is above a predetermined level, and allows fluid flow from said chamber to said outlet when the level of the liquid in said chamber is below the predetermined level.

2. The apparatus of claim 1 wherein said venting device is connected to an upper end of said shell.

3. The apparatus of claim 1 wherein said float valve device is configured to be closed when the level of the liquid in said chamber is above the predetermined level, and is configured to be open when the level of the liquid in said chamber is below the predetermined level.

4. The apparatus of claim 1 wherein said pivot arm is configured to be pivoted by said float.

5. The apparatus of claim 1 wherein said pivot arm is configured to pivot about a port pivot axis when actuated by said float to thereby substantially seal a port, said port fluidly interconnecting said chamber and said outlet when said port is unsealed.

6. The apparatus of claim 5 wherein said port pivot axis is disposed between a first end portion of said pivot arm and a second end portion of said pivot arm, said first end portion being connected to said float, said second end portion being configured to counterbalance said first end portion.

7. The apparatus of claim 5 wherein said pivot arm includes a projection extending therefrom in a direction substantially perpendicular to a longitudinal axis of said pivot arm, said projection being configured to substantially seal said port when said pivot arm is actuated by said float.

8. The apparatus of claim 7 wherein said pivot arm is connected to said float at a connection point, said projection being closer to said port pivot axis than to said connection point.

9. The apparatus of claim 1 wherein said pivot arm is pivotably connected to said float.

10. The apparatus of claim 1 further comprising a check valve configured to:
prevent ambient air from entering said chamber through said outlet; and
enable the gas to escape said chamber through said outlet.

11. A venting device for releasing gas from a closed vessel containing a liquid, said venting device including:
an inlet configured to be in fluid communication with the vessel;
an outlet in fluid communication with ambient air;
a chamber interconnecting said inlet and said outlet; and
a valve device configured to control fluid flow between said chamber and said outlet, said valve device including a pivoting arrangement configured to be actuated by changes in a level of the liquid in said chamber such that said valve device prevents fluid from flowing from said chamber to said outlet when the level of the liquid in said chamber is above a predetermined level, and said valve device allows fluid to flow from said chamber to said outlet when the level of the liquid in said chamber is below the predetermined level.

12. The venting device of claim 11 wherein said valve device includes
a float configured to follow a level of the liquid in said chamber; and
a pivot arm connected to said float and configured to be pivoted by said float.

13. The apparatus of claim 11 wherein said pivoting arrangement includes a pivot arm configured to pivot about a port pivot axis when actuated by the liquid level changes to thereby substantially seal a port, said port fluidly interconnecting said chamber and said outlet when said port is unsealed.

14. The apparatus of claim 13 wherein said port pivot axis is disposed between a first end portion of said pivot arm and a second end portion of said pivot arm, said second end portion being configured to counterbalance said first end portion.

15. The apparatus of claim 13 wherein said pivot arm includes a projection extending therefrom in a direction substantially perpendicular to a longitudinal axis of said pivot arm, said projection being configured to substantially seal said port when said pivot arm is actuated by the liquid level changes.

16. The apparatus of claim 11 further comprising a check valve configured to:
prevent ambient air from entering said chamber through said outlet; and
enable the gas to escape said chamber through said outlet.

17. A venting device for releasing gas from a closed vessel containing a liquid, said venting device including:
a chamber configured to receive a fluid flow from the vessel; and
a valve device configured to control fluid flow out of said chamber through a port, said valve device including a pivot arm configured to be pivoted as a result of changes in a level of the liquid in said chamber such that said pivot arm selectively substantially seals and unseals said port.

18. The device of claim 17 wherein said pivot arm is configured to pivot about a port pivot axis, said port pivot axis being disposed between a first end portion of said pivot arm and a second end portion of said pivot arm, said second end portion being configured to counterbalance said first end portion.

19. The device of claim 18 wherein said first end portion of said pivot arm is configured to have an upward force exerted thereon by a rising liquid level.

20. The device of claim 18 further comprising a float connected to said first end portion of said pivot arm.
